(19) United States
(12) Patent Application Publication
(10) Pub. No.: US 2004/0185307 A1
(43) Pub. Date: Sep. 23, 2004

(54) Perpendicular magnetic recording medium and method for manufacturing the same

(76) Inventors: Tadaaki Oikawa, Nagano (JP); Hiroyuki Uwazumi, Nagano (JP)

Correspondence Address: ROSSI & ASSOCIATES, P.O. Box 826, Ashburn, VA, 20146-0826, US

(21) Appl. No.: 10/743,654

(22) Filed: Dec. 22, 2003

(30) Foreign Application Priority Data
Dec. 20, 2002 (JP) JP 2002-370559

(51) Int. Cl. G11B 5/70

(52) U.S. Cl. 428/694 TP; 428/694 R

(57) ABSTRACT

A magnetic recording medium includes a magnetic recording layer composed of an L10 type ordered alloy at a low temperature. The magnetic recording layer of the L10 type ordered alloy exhibits high magnetic anisotropy energy Ku that is necessary for compatibility between improvement in thermal stability and reduction of noises. Specifically, the recording medium includes a nonmagnetic substrate, a nonmagnetic underlayer, a magnetic recording layer, a protective layer, and a liquid lubricant layer sequentially formed on the substrate. The magnetic recording layer is formed by alternately depositing an iron or cobalt layer having thickness in a range of 0.1 nm to 0.3 nm and a platinum layer having thickness of in a range of 0.15 nm to 0.35 nm repetitively. The magnetic recording layer is mainly composed of an alloy of FePt or CoPt that includes a region with an L10 type ordered structure.

### FIELD OF THE INVENTION

The present invention relates to a perpendicular magnetic recording medium mounted on various magnetic recording apparatuses including an external storage device of a computer, and also relates to a method for manufacturing a perpendicular magnetic recording medium.

### BACKGROUND OF THE INVENTION

The recording density of magnetic recording media has been rising at a remarkable rate, and this trend is likely to continue. In a conventional longitudinal recording system, a problem of thermal fluctuation of magnetization exists that results from the reduction of magnetic particles size and magnetic layer thickness which are required for enhancement of recording density. Thermal fluctuation is considered to have a limiting effect on high recording density. In recent years, studies on perpendicular magnetic recording media are rapidly proceeding in order to solve this problem. However, the perpendicular magnetic recording media also needs reduction of noise levels and improvement in thermal stability for higher density recording, which requires enhancement of the value of perpendicular magnetic anisotropy energy Ku. Because reduction of the recording layer thickness also becomes indispensable, the selection of material becomes essential that exhibits a high value of perpendicular magnetic anisotropy energy Ku even in a thin magnetic recording layer.

In conventional thin films mainly composed of a CoCr alloy, particularly, in a granular alloy where nonmagnetic substance such as an oxide is precipitated at a grain boundary region between magnetic particles, each of the magnetic particles is nearly perfectly isolated magnetically by the intervening nonmagnetic substance. Each magnetically isolated particle behaves as a minimum magnetization unit and growth of big cluster is suppressed. Thus, significant noise reduction effect has been confirmed in such an alloy.

In the above-mentioned granular type magnetic recording medium, however, particles of minute size are almost completely isolated with each other by nonmagnetic substance. Consequently, the volume of the magnetic particles is very small and the magnitude of magnetic anisotropy energy is nearly the same as the magnitude of thermal energy. When the magnetic anisotropy energy is the same order of magnitude as the thermal energy, the direction of spin fluctuates perpetually due to thermal agitation, failing to stably hold the records. Thus, practical application of a medium employing a granular alloy is considered difficult because of the problems of thermal stability and long-term storage stability.

To solve these problems, enhancement of the magnetic anisotropy energy of magnetic substance is essential. For this purpose, studies are being made to use an ordered alloy such as CoPt and FePt having an L10 structure (or CuAu type structure) exhibiting high crystalline magnetic anisotropy. These materials, however, include a metastable phase of a disordered fcc structure. FePt, for example, has to be heat-treated at 600° C. or higher to achieve the ordered structure of L10 system. In the case the magnetic recording layer is made thinner corresponding to higher recording density, this ordering process is important since the crystallinity of the alloy degrades with decrease of film thickness. The high temperature heating process is not compatible with mass-production. In addition, the high temperature heat-treatment causes coarsening of crystal grains, which increases interaction between particles. Therefore, lowering of the ordering process temperature is an important problem.

Concerning the lowering of the ordering process temperature of an ordered alloy film, there is reported until now that an L10 ordered alloy film is laminated while heating to 500° C. a substrate with an underlayer having a NaCl type crystal structure or a LiCl type crystal structure. (See Japanese Unexamined Patent Application Publication No. 2001-189010) Also reported is a method for forming an L10 ordered alloy (FePt) film at a substrate temperature between 400° C. and 500° C. by means of a sputtering method with a specified range of argon gas pressure and a target-to-substrate spacing, depositing on an underlayer that has a crystal plane of Miller index (100) parallel to the substrate surface. (See Japanese Unexamined Patent Application Publication No. H11-353648)

There is further reported that lowering of ordering process temperature by adding another substance containing a metallic element to an ordered alloy film, for example, adding MgO to a FePt film. (See Japanese Unexamined Patent Application Publication No. 2002-123920) The addition of metallic element, although lowered the ordering process temperature to around 400° C., has raised, on the other hand, a problem of decrease of magnetic anisotropy energy Ku. Thus, it is a problem for extensive studies at present to lower the temperature of synthesizing an ordered alloy while preventing decrease of the Ku value.

Under the present status in which a magnetic recording material having a thickness from 3 nm to 15 nm is demanded for higher recording density on a magnetic recording medium, a method is intensely desired to form at a lower temperature an L10 type ordered alloy exhibiting high magnetic anisotropy energy Ku that is required by noise reduction compatible with improvement of thermal stability. More specifically, in order to eliminate restriction on a substrate material imposed by the high temperature heat-treatment and suppress increase of interaction between particles, a method is strongly desired to be provided that allows ordering an L10 type ordered alloy at a lower temperature, for example, lower or equal to 400° C.

### SUMMARY OF THE INVENTION

The inventors of the present invention have made intensive studies and have solved the problem to lower the ordering process temperature for the ordered alloy, by alternately depositing by a sputtering method a cobalt layer (or an iron layer) and a platinum layer to a thickness of a monoatomic layer (about 1.77 Å for cobalt, about 1.43 Å for iron, and about 1.96 Å for platinum). Since the transformation from a metastable fcc structure to an L10 type ordered fct structure can be promoted even at a low temperature by an atomic diffusion, the ordering process temperature has been remarkably lowered without noticeably degrading magnetic performance. Specifically, while heat treatment at 600° C. or higher was conventionally necessary, a method according to the present invention allows ordering at a temperature from a room temperature to 400° C.

A magnetic recording medium and a method for manufacturing the medium are prevented from coarsening of grains due to high temperature heat treatment and free from restriction of substrate material because the ordering process temperature is lowered to lower than or equal to 400° C. A method for manufacturing a magnetic recording medium according to the invention can be executed at such a low temperature that raises no problem in mass production. It is more effective to provide a nonmagnetic seed layer that is disposed between a nonmagnetic substrate and a nonmagnetic underlayer and has a dominant alignment crystal plane of (100) plane. The nomnagnetic seed layer can be composed of a substance with a NaCl type structure including MgO, NiO, TiO., a titanium carbide, and a titanium nitride.

### BRIEF DESCRIPTION OF DRAWINGS

The invention will be described with reference to certain preferred embodiments thereof along with the accompanying drawings, wherein:

FIG. 1(a) is a schematic cross sectional view of a magnetic recording medium according to the present invention;

FIG. 1(b) is a schematic cross sectional view illustrating a lamination structure of a magnetic recording layer;

FIG. 2 is a graph showing coercive force Hc and perpendicular magnetic anisotropy energy Ku of media that are heat treated at Ts=300° C. for 1 hr after formation of all layers as functions of thickness of the magnetic recording layer;

FIG. 3 is a graph showing perpendicular magnetic anisotropy energy Ku and coercive force Hc of magnetic recording media comprising a magnetic recording layer of an FePt ordered alloy having a fixed thickness of 10 nm as functions of heat treatment temperature; and

FIG. 4 is a graph showing perpendicular magnetic anisotropy energy Ku of magnetic recording media of CoPt ordered alloy and media of FePt ordered alloy having a magnetic recording layer having a fixed thickness of 10 nm as functions of heat treatment temperature.

### DETAILED DESCRIPTION OF THE PREFERRED EMBODIMENTS

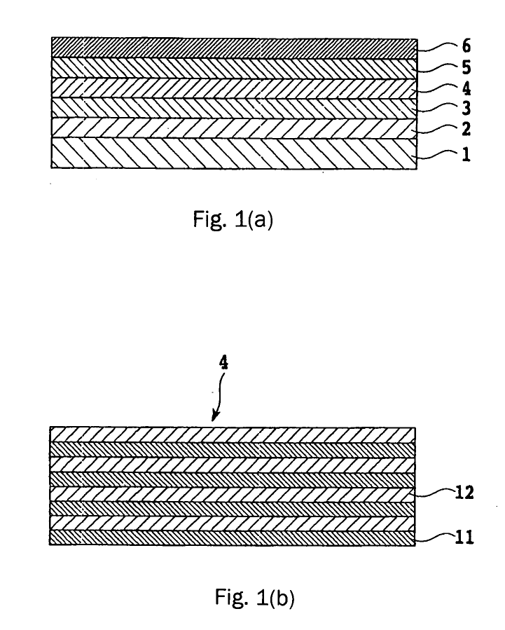

Some aspects of preferred embodiment of the invention will be described in the following. FIG. 1(a) is a schematic cross sectional view of a perpendicular magnetic recording medium according to the present invention. The medium has a structure comprising a nonmagnetic substrate 1, and the layers including a nonmagnetic seed layer 2, a nonmagnetic underlayer 3, a magnetic recording layer 4, and a protective layer 5 sequentially laminated on the substrate 1. A liquid lubricant layer 6 is further formed on the resulted lamination.

FIG. 1(b) is a cross sectional view illustrating a lamination method of the magnetic recording layer 4 in which a cobalt (or iron) layer and a platinum layer, each having a thickness of a monoatomic layer, are alternately deposited repetitively, which is one of the most noteworthy features of the invention. While the example of FIG. 1(b) shows a magnetic recording layer 4 that has four layers of each type of layers, the desired thickness of the magnetic recording layer can be obtained by appropriately controlling the number of laminations.

A nonmagnetic substrate 1 can be composed of a material used in a usual magnetic recording medium including an aluminum alloy with NiP plating, strengthened glass, crystallized glass, or composed of a silicon wafer with oxidized surface or a fused silica substrate. In addition, a plastic resin substrate can be used as well that is made by injection molding plastic resin such as polycarbonate, polyolefin, or the like.

A nonmagnetic seed layer 2 is composed of a material selected from MgO, NiO, TiO, a titanium carbide, and a titanium nitride wherein a crystal lattice plane of Miller index (100) is controlled parallel to the substrate. That is, the dominant crystal alignment plane is (100) plane. While these materials can be deposited so that the (100) plane is a dominant alignment crystal plane even under a common condition, the degree of (100) alignment can be improved by optimizing a film thickness and a deposition process condition, for example, pressure. By sequentially forming a nonmagnetic underlayer 3 and a magnetic recording layer 4, which structure is a featured layer structure of the invention, on the nonmagnetic seed layer 2, the crystal lattice plane of Miller index (001) of an L10 type ordered alloy phase in the magnetic recording layer 4 can be controlled parallel to the adjacent layers and the substrate. The optimum thickness of the nonmagnetic seed layer 2 is preferably in the range of 3 nm to 15 nm depending on the substance of the seed layer. The nonmagnetic seed layer 2 can be deposited by a common method in the art including vapor deposition, sputtering, ion plating, laser ablation, and ion beam deposition.

A nonmagnetic underlayer 3 is provided primarily for the purpose of controlling crystal alignment and a grain size of the magnetic recording layer. Accordingly, the underlayer is composed of a film with a material and a structure that are suited to the desired alignment plane of the ordered alloy film of the magnetic layer. The material for the underlayer can be selected from metals including Ag, Al, Au, Cu, Ir, Ni, Pt, and Pd, and alloys of at least one of these metals, which have an fcc structure, and chromium and chromium alloys, which have a bcc structure. By using one of these metals and alloys, the dominant crystal alignment plane of (001) plane can be achieved of the L10 type ordered alloy in the magnetic layer that is deposited on the nonmagnetic underlayer 3 having a surface of (200) plane. In order to control the grain size of the L10 type ordered alloy in the magnetic layer 4 below or equal to 5 nm, optimization of film thickness and deposition process condition of the nonmagnetic underlayer and the magnetic recording layer is necessary, and the optimization can be attained, for example, by reducing thickness of the underlayer. A thickness of the underlayer is preferably in a range of 5 nm to 50 nm for controlling structure of the magnetic recording layer. The nonmagnetic underlayer 3 can be deposited by a common method in the art including vapor deposition, sputtering, ion plating, laser ablation, and ion beam deposition

The magnetic recording layer 4 is formed by alternately depositing a cobalt or iron layer and a platinum layer, each having a thickness corresponding to a thickness of a monoatomic layer of about 1.77 Å for cobalt, about 1.43 Å for iron, and about 1.96 Å for platinum, repetitively. The magnetic recording layer 4 can be deposited by a method selected from vapor deposition, sputtering, ion plating, laser ablation, and ion beam deposition, preferably by a DC magnetron sputtering method. One possible method to alternately deposit the different elements in a single chamber is a sputtering method that uses a rotary cathode composed of these elements. The method can appropriately form a desired laminated film.

When cobalt layers are laminated, the thickness of each layer is in a range of 0.1 nm to 0.3 nm, preferably in the range of 0.17 nm to 0.20 nm. In the case iron layers are laminated, the thickness of each layer is in a range of 0.1 nm to 0.3 nm, preferably in the range of 0.14 nm to 0.16 nm. When platinum layers are laminated, the thickness of each layer is in a range of 0.15 nm to 0.35 nm, preferably from 0.19 to 0.21 nm. The total thickness of the magnetic recording layer 4 can be suitably controlled by the number of layers of those elements. The total thickness of the magnetic recording layer 4 is in a range of 3 nm to 15 nm, preferably from 3 nm to 5 nm.

Transformation of the deposited CoPt or FePt alloy for the magnetic recording layer 4 into an ordered state can be accomplished by heating the nonmagnetic substrate during the time of deposition of the alloy, or by heat-treatment after the deposition or after formation of a protective layer and a liquid lubricant layer, which will be described later. When the ordering is conducted by heating during the deposition process, the deposition and ordering can be performed at any temperature of the nonmagnetic substrate as long as the heating has no adverse effect on the previously formed layers. Temperature of the substrate that can be employed is lower or equal to 400° C., preferably in the range of 200° C. to 400° C., more preferably in the range of 300° C. to 400° C. When the substrate is an aluminum substrate with NiP plating, the temperature of the substrate is lower or equal to 300° C., preferably in a range of 200° C. to 300° C., more preferably 250° C. to 300° C. to avoid crystallization of the NiP. Deposition at the above-described temperature of the substrate can form a sufficiently ordered layer of an L10 type ordered alloy. When the ordering process is conducted by heat-treatment after deposition of the magnetic recording layer or after formation of a protective layer and a liquid lubricant layer, the deposition process of the magnetic recording layer may be conducted at any temperature of the substrate, for example, below 200° C.

When the ordering of the CoPt or FePt alloy is conducted after deposition of the alloy or after formation of a protective layer and a liquid lubricant layer, heat-treatment is conducted at a temperature lower or equal to 400° C., preferably in a range of 200° C. to 400° C., more preferably 300° C. to 400° C. for 0.5 to 2 hr, preferably 0.5 to 1 hr. Such heat treatment transforms a magnetic recording layer deposited without heating of the substrate to a sufficiently ordered layer of L10 type ordered alloy. When the nonmagnetic substrate is an aluminum substrate with NiP plating, the heat treatment may be conducted at a temperature lower or equal to 300° C., preferably in a range of 200° C. to 300° C., more preferably 250° C. to 300° C. for avoiding crystallization of the NiP.

A heat treated CoPt ordered alloy exhibits a perpendicular magnetic anisotropy energy Ku in a range of 7×10⁵ J/m³ to 3×10⁶ J/m³ (7×10⁶ erg/cm³ to 3×10⁷ erg/cm³), preferably in a range of 1×10⁶ J/m³ to 3×10⁶ J/m³ (1×10⁷ erg/cm³ to 3×10⁷ erg/cm³). A heat treated FePt ordered alloy exhibits a perpendicular magnetic anisotropy energy Ku in a range of 7×10⁵ J/m³ to 7×10⁶ J/m³ (7×10⁶ erg/cm³ to 7×10⁷ erg/cm³), preferably 1×10⁶ J/m³ to 7×10⁶ J/m³ (1×10⁷ erg/cm³ to 7×10⁷ erg/cm³). Having these high Ku values, a magnetic recording layer 4 retains high thermal stability and allows recording with reduced noises even if decrease of film thickness and miniaturization of grain size make the volume of each particle minute.

The structure and the degree of ordering of crystalline particles composing a magnetic recording layer 4 can be confirmed by a common apparatus for X-ray diffraction. If the peak representing the plane of fct-(001), (002), or (003) is observed, it can be assumed that an fct structure exists and the c-axis orients perpendicular to the film surface. Intensity of the peak representing the plane of fct-(001), (002), or (003) is sufficient if the intensity of the observed peak is significant with respect to the background level. Despite detection of fct-(111) peak indicating in-plane orientation, if the peak representing fct-(001), (002), or (003) peak is observed with high intensity than the fct-(111) peak, the c-axis can be assumed aligning perpendicularly to the film surface. When crystalline particles of the alloy is completely disordered, an intensity ratio I(001)/I(111) of the peak intensity I(001) of fct-(001) to the peak intensity I(111) of fct-(111) is around 0.3. If the intensity ratio I(001)/I(111) is larger than or equal to 1.0, the c-axis of the crystalline particle can be regarded aligning perpendicular to the film surface in the present invention. More preferably, the ratio I(001)/I(111) is larger than 10.

Protective film 5 can be a thin film composed mainly of carbon such as diamond-like carbon (DLC). Other thin film materials that are commonly used for a protective film of a magnetic recording medium can also be used. Such materials include silicon carbide (SiC), zirconium oxide (ZrO₂), and carbon nitride (CN). The protective film 5 can be laminated by means of a common method in the art, for example, vapor deposition, sputtering, ion plating, laser ablation, CVD, or ion beam deposition. The protective film 5 has a thickness favorably in a range of 1 to 5 nm, more favorably 2 to 4 nm.

Liquid lubricant layer 6 can be formed with a fluorocarbon lubricant, for example, a perfluoropolyether lubricant. One of the other lubricant materials that are commonly used for a liquid lubricant material of a magnetic recording medium may also be used. The liquid lubricant layer 6 can be formed by means of a common method in the art including dip-coating, spraying, spin coating, and knife coating. The liquid lubricant layer 6 has a thickness in a range of 0.5 to 5 nm, preferably 1 to 2 nm.

### EXAMPLE 1

The nonmagnetic substrate used was a strengthened glass disk substrate with a diameter of 2.5 inches. After cleaning, the substrate was introduced into a sputtering chamber. A nonmagnetic seed layer 5 nm thick was formed by an RF sputtering method using a target of MgO under argon gas pressure of 0.67 Pa (5 mTorr). Subsequently, a nonmagnetic underlayer of platinum 20 nm thick was formed by a DC sputtering method using a target of platinum under argon gas pressure of 0.67 Pa (5 mTorr). After that, a magnetic recording layer 4 was formed by alternately laminating a monoatomic layer of cobalt (0.177 nm) and a monoatomic layer of platinum (0.196 nm) repetitively by a DC magnetron sputtering method under argon gas pressure of 2 Pa (15 mTorr) alternately using a cobalt target and a platinum target in the conditions of a target potential of 400 V, an RF output power of 200 W, and a target-substrate spacing of 8 cm.

Magnetic recording media having various thicknesses δ of the magnetic recording layer from δ=5 nm to 30 nm were produced by adjusting number of lamination. In the same way, magnetic recording media comprising a magnetic recording layer composed of an FePt ordered alloy were produced by alternately laminating a monoatomic layer of iron (0.143 nm) and a monoatomic layer of platinum (0.186 nm) repetitively.

After that, a protective film 5 nm thick was formed by a DC sputtering method using a carbon target under argon gas pressure of 0.67 Pa (5 mTorr). Finally, a liquid lubricant layer 2 nm thick was formed by dip-coating with perfluoropolyether lubricant. After all layers are formed, heat treatment was conducted under a condition of a substrate temperature of 300° C. for one hour.

Table 1 shows intensity ratio I(001)/I(111) of the fct-(001) diffraction peak and the fct-(111) diffraction peak in relation with the magnetic recording layer thickness of the thus produced magnetic recording layer of CoPt and FePt ordered alloys measured using a thin film X-ray diffraction system. Table 1 shows that the peak intensity ratio, which indicates the degree of ordering, increases with increase of the recording layer thickness. This can be considered arisen because crystallinity enhances with increase of the recording layer thickness. The peak intensity ratio is around 100 for every example of the embodiments having various magnetic recording layer thickness. These data shows that sufficient ordering has been achieved by heat treatment at a temperature of 300° C. As described above, an ordering process temperature of an L10 type ordered alloy has been remarkably lowered by alternately laminating component types of atoms with a thickness corresponding to a monoatomic layer.

TABLE 1
Dependence of Intensity Ratio I(001)/I(111)
on Magnetic Recording Layer Tthickness

recording thickness layer (nm)

| material | 5 | 10 | 15 | 20 |
|---|---|---|---|---|
| CoPt | 73 | 79 | 105 | 111 |
| FePt | 88 | 92 | 118 | 119 |

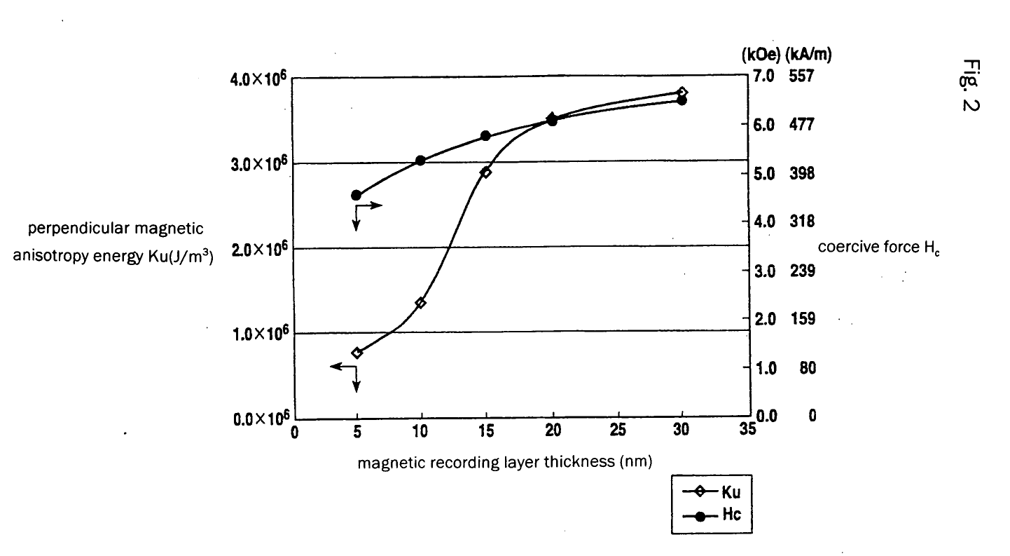

FIG. 2 is a graph showing coercive force Hc and perpendicular magnetic anisotropy energy Ku of media of CoPt ordered alloy of Example 1 in relation with the magnetic recording layer thickness. The Hc was measured by a vibrating sample magnetometer (VSM) and the Ku value was measured by a torque magnetometer. The figure shows that both He and Ku increase with increase of the film thickness like the variation of the peak intensity ratio. It should be noted that very large values in Hc and Ku were obtained in the medium with thin layer thickness of 5 nm, such as He=370 kA/m (4.6 kOe) and Ku=7.8×10⁵ J/m³ (7.8×10⁶ erg/cc).

### EXAMPLE 2

Perpendicular magnetic recording media were produced in the same manner as in Example 1 except that the thickness of the recording layer was fixed at 10 nm and the temperature Ts of heat treatment after lamination of all layers was varied in a range of the room temperature (which means no heat treatment, that is, an as-deposited condition) to 500° C.

Table 2 shows the ratio I(001)/I(111) of the thus produced media of CoPt and FePt ordered alloys in relation with the heat treatment temperature. Duration of the heat treatment was 1 hr as in Example 1. As Table 2 shows, degree of ordering increases with elevation of the heat treatment temperature in both CoPt and FePt alloys. At 400° C., the peak of fct-(111) was hardly identified.

TABLE 2
Dependence of Intensity Ratio I(001)/I(111)
on Heat Treatment Temperature

| Ts (° C.) | CoPt | FePt |
|---|---|---|
| 25 | 2 | 3 |
| 100 | 4 | 5 |
| 200 | 15 | 21 |
| 300 | 98 | 115 |
| 400 | >>1000 | >>1000 |

The fct-(001) peak was also identified at the room temperature (at 25° C. in Table 2, in an as-deposited condition). The peak intensity ratio I(001)/I(111), though not large, is larger than the peak intensity ratio for random orientation 0.3, which indicates dominant alignment in the (001) plane. Small values of the peak intensity ratio can be attributed to relatively inferior crystallinity and inhomogeneous ordering on the film surface. By fully controlling alignment in the seed layer and the underlayer and by process optimization in the magnetic recording layer, sufficient ordering can be achieved even at a heat treatment temperature lower or equal to 200° C.

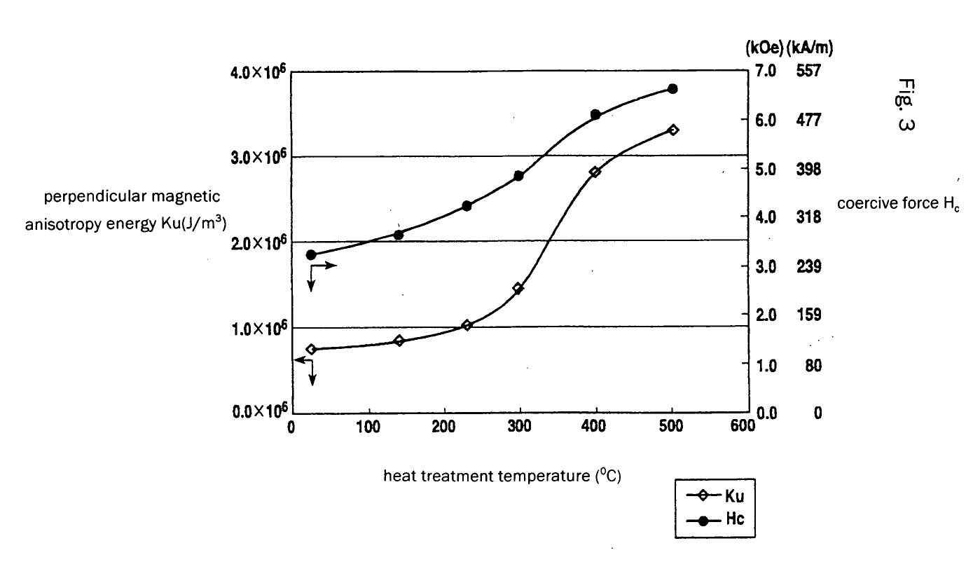

FIG. 3 is a graph showing perpendicular magnetic anisotropy energy Ku and coercive force Hc of magnetic recording media comprising a magnetic recording layer of an FePt ordered alloy of Example 2 as functions of heat treatment temperature. The Hc and Ku values increase with elevation of the heat treatment temperature like variation of the peak intensity ratio. Even at the room temperature (that is, in an as-deposited condition), the large values of Hc=250 kA/m (3.2 kOe) and Ku=6.9×10⁵ J/m³ (6.9×10⁶ erg/cc) were obtained.

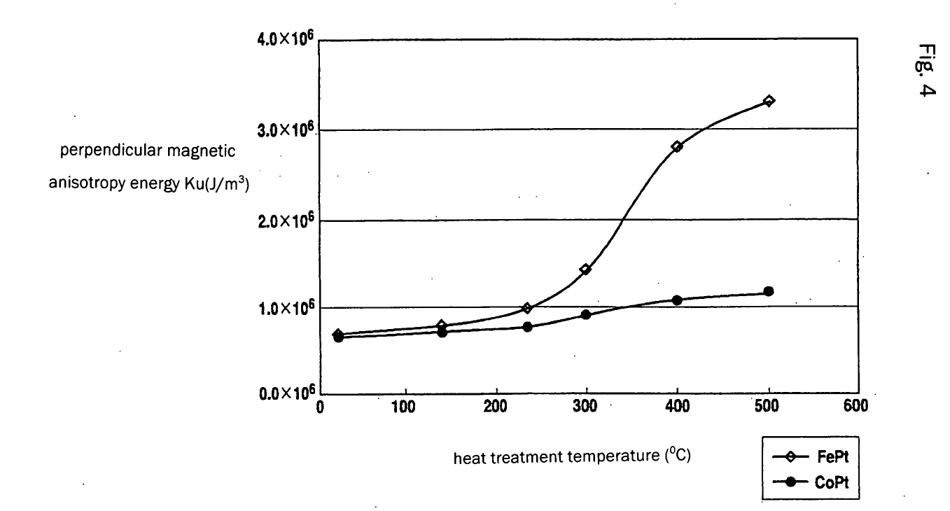

FIG. 4 is a graph showing comparison of Ku value for magnetic recording media using CoPt and FePt ordered alloys of Example 2 as functions of heat treatment temperature. As shown in FIG. 4, Ku values for both types of media are large even at the room temperature (that is in an as-deposited condition). The reason for large difference between Ku values for the media of CoPt and FePt ordered alloys in the high temperature region is because the Ku value in a bulk of the CoPt ordered alloy is 3.0×10⁶ J/m³ (3.0×10⁷ erg/cc) and the Ku value in a bulk of the FePt ordered alloy is 7.0×10⁶ J/m³ (7.0×10⁷ erg/cc) and thus, the FePt ordered alloy exhibits larger perpendicular magnetic an isotropy.

### EXAMPLE 3

Magnetic recording media comprising a magnetic recording layer 10 nm thick composed of the CoPt ordered alloy were produced in the same manner as in Example 1 except that the nonmagnetic substrate was heated at 300° C. using a heater during depositing the magnetic recording layer in place of heat treatment after laminating all layers consisting a magnetic recording medium. In the same way, a magnetic recording medium comprising a magnetic recording layer 10 nm thick composed of a FePt ordered alloy was produced.

Comparison of performances was made between the media of CoPt and FePt ordered alloys produced in the above-described method and the media that were heat treated at 300° C. for one hour after formation of all layers. The result is shown in Table 3.

TABLE 3
Comparison Between Heating During Deposition and
After Deposition

| magnetic | heating | | | |
|---|---|---|---|---|
| layer | during deposition (Ex 3) | | heating after deposition (Ex 1) | |
| material | I(001)/I(111) | Ku(MJ/m³) | I(001)/I(111) | Ku(MJ/m³) |
| CoPt | 73 | 0.89 | 79 | 0.91 |
| FePt | 84 | 1.12 | 92 | 1.42 |

Performances of the media of Example 3 that were ordered by heating the substrate during deposition of magnetic recording layer were proved not significantly inferior to the peak intensity ratio and the magnetic anisotropy value Ku of the medium of Example 1 that were subjected to post heat treatment in both types of ordered alloys of CoPt and FePt, although numerical values were a little smaller in Example 3 than in Example 1. It has been revealed from the results that a magnetic recording layer composed of CoPt and FePt ordered alloys exhibits excellent performances by heating during deposition in place of conducting post heat treatment. The method of Example 3 is particularly useful in mass production of magnetic recording media.

As described so far, the lamination method of ordered alloys according to the present invention can remarkably lower the ordering process temperature for CoPt and FePt as compared with a conventional sputtering method using a target of CoPt or FePt alloy or a conventional co-sputtering method in which cobalt (or iron) and platinum are simultaneously sputtered. Therefore, the restriction on substrate material selection has been eliminated and coarsening of grains, which intensify interaction between grains, due to a thermal process has been suppressed.

A magnetic recording medium according to the present invention comprising such a thin magnetic recording layer of only 5 nm, by heat treatment at 300° C., exhibits significantly larger values of coercive force Hc and perpendicular magnetic anisotropy energy Ku as compared with a conventional perpendicular medium comprising a CoCrPt magnetic layer. Thus, the medium of the invention meets the requirements for thin recording layer and high Ku value that will be essential for high recording density in the future. A magnetic recording medium with excellent performance can be obtained employing heating during deposition of a magnetic recording layer, which is an advantageous process for mass production, in place of conducting post heat treatment.

What is claimed is:

1. A perpendicular magnetic recording medium comprising a nonmagnetic substrate and layers laminated sequentially on the substrate, the layers including a nonmagnetic underlayer, a magnetic recording layer, a protective layer, and a liquid lubricant layer, wherein the magnetic recording layer is formed by alternately laminating an iron or cobalt layer having thickness in a range of 0.1 nm to 0.3 nm and a platinum layer having thickness in a range of 0.15 nm to 0.35 nm repetitively, and is mainly composed of an alloy of FePt or CoPt including a region of L10 type ordered lattice.

2. A perpendicular magnetic recording medium according to claim 1, wherein a thickness of the magnetic recording layer is in a range of 3 nm to 15 nm.

3. A perpendicular magnetic recording medium according to claim 1, wherein a (001) crystal lattice plane in the region of L10 type ordered lattice is formed in parallel to a surface of the magnetic recording layer.

4. A perpendicular magnetic recording medium according to claim 1, wherein the underlayer is composed of a metal being selected from a group consisting of Ag, Al, Au, Cu, Ir, Ni, Pt, and Pd, or an alloy mainly composed of at least one metal selected from the group consisting of Ag, Al, Au, Cu, Ir, Ni, Pt, and Pd, or the underlayer is composed of chromium or chromium alloy.

5. A perpendicular magnetic recording medium according to claim 1, wherein the underlayer has a thickness in a range of 5 nm to 50 nm.

6. A perpendicular magnetic recording medium according to claim 1 further comprising a nonmagnetic seed layer between the substrate and the underlayer, wherein the seed layer is composed of MgO, NiO, TiO, or titanium carbide or titanium nitride, and a dominant crystal alignment plane of the seed layer is (100) plane.

7. A perpendicular magnetic recording medium according to claim 6, wherein the seed layer has a thickness in a range of 3 nm to 15 nm.

8. A perpendicular magnetic recording medium according to claim 1, wherein the substrate is selected from a group consisting of an aluminum substrate, a silicon wafer with an oxidized surface, a fused quartz substrate, a glass substrate, and a plastic resin substrate.

9. A perpendicular magnetic recording medium according to claim 1, wherein perpendicular magnetic anisotropy energy Ku of the magnetic recording layer is in a range of 7×10⁵ J/m³ to 7×10⁶ J/m³.

10. A perpendicular magnetic recording medium according to claim 1, wherein the magnetic recording layer is formed by means of a DC magnetron sputtering method.

11. A method for manufacturing a perpendicular magnetic recording medium comprising:
preparing a nonmagnetic substrate;
forming a nonmagnetic underlayer on the substrate;
forming a magnetic recording layer mainly composed of an alloy comprising FePt or CoPt including a region of L10 type ordered lattice on the underlayer by laminating alternately an iron or cobalt layer having thickness in a range of 0.1 nm to 0.3 nm and a platinum layer having thickness in a range of 0.15 nm to 0.35 nm, repetitively; and
forming a protective layer on the magnetic recording layer, and forming a liquid lubricant layer on the protective layer.

12. A method for manufacturing a perpendicular magnetic recording medium according to claim 11, wherein the magnetic recording layer is formed by means of a DC magnetron sputtering method.

13. A method for manufacturing a perpendicular magnetic recording medium according to claim 11 further comprising a step of heating at a temperature lower or equal to 400° C. after the step of forming the magnetic recording layer.

14. A method for manufacturing a perpendicular magnetic recording medium according to claim 11, wherein a temperature of the substrate in the step of forming the magnetic recording layer is lower or equal to 400° C.
